(19) United States
(12) Patent Application Publication
(10) Pub. No.: US 2014/0177116 A1
(43) Pub. Date: Jun. 26, 2014

(54) POWER-OFF PROTECTION SYSTEM AND METHOD

(71) Applicant: HON HAI PRECISION INDUSTRY CO., LTD., New Taipei (TW)

(72) Inventors: PO-WEI WANG, New Taipei (TW); LI-WEN CHANG, New Taipei (TW); CHIH-CHUNG SHIH, New Taipei (TW)

(73) Assignee: HON HAI PRECISION INDUSTRY CO., LTD., New Taipei (TW)

(21) Appl. No.: 13/965,200

(22) Filed: Aug. 13, 2013

(30) Foreign Application Priority Data
Dec. 25, 2012 (TW) 101149658

(51) Int. Cl. H02H 3/38

(52) U.S. Cl. CPC H02H 3/38
USPC 361/90

(57) ABSTRACT

A power-off protection system used in a multi-node system includes a detecting module. The detecting module obtains voltage, current and temperature information of all of the nodes and power supplying units in the multi-node system periodically. A determining module determines if any node from the nodes and power supplying units is abnormal. A control module controls a switch connected with the node that is abnormal to turn off, thereby turning off power source connected with the node that is abnormal.

### BACKGROUND

1. Technical Field

The present disclosure relates to power-off protection systems and methods, more particularly, to a power-off protection system and method used in multi-node systems.

2. Description of Related Art

Main-boards can be powered off to protect themselves when a voltage, a current, and/or a temperature are abnormal. However, there is no available method to apply power-off protection in a multi-node system.

Therefore, it is desirable to provide power-off protection system and method for use in multi-node systems, which can overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a schematic view of an embodiment of a multi-node system.

FIG. 2 is a schematic view of a power-off protection system used in the multi-node system in FIG. 1.

FIG. 3 is a flowchart of an embodiment of a power-off protection method of protecting the multi-node system of FIG. 1.

### DETAILED DESCRIPTION

Embodiments of the present disclosure will be described with reference to the drawings.

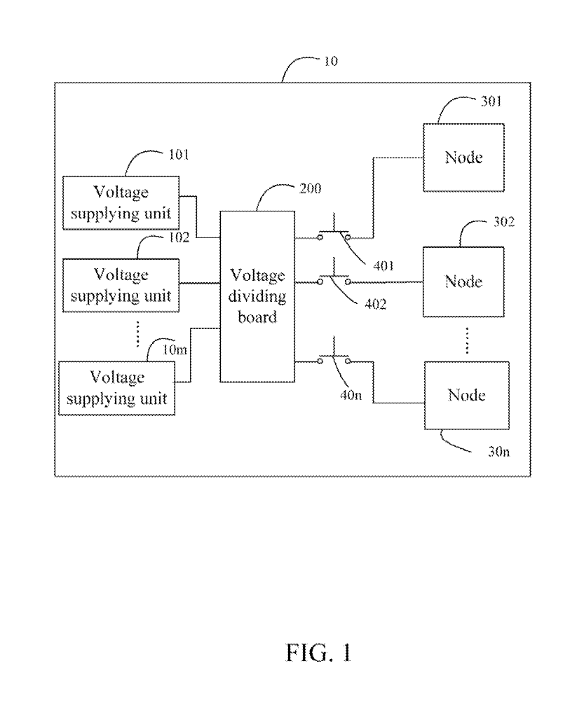

FIG. 1 is a schematic view of an embodiment of a multi-node system. The multi-node system 10 includes several power supplying units 101, 102, . . . 10m, a voltage dividing board 200, and several nodes 301, 302, . . . 30n. Each one of the nodes 301, 302, . . . 30n can be a server or a mainboard.

The power supplying units 101, 102, . . . 10m supply electrical power for the nodes in the multi-node system 10. The voltage dividing board 200 converts the electrical power into working voltages, and sends the working voltages to the nodes 301, 302, . . . 30n. The voltage dividing board 200 is a programmable chip, for example, NXP LPC1768.

The multi-node system 10 further includes several switches 401, 402, . . . , 40n. A quantity of the switches 401, 402, . . . , 40n is the same as the quantity of the nodes 301, 302, . . . 30n. One end of each of the switches 401, 402, . . . , 40n is connected with the voltage dividing board 200, and the other end of each of the switches 401, 402, . . . , 40n is connected with one node of the nodes 301, 302, . . . 30n.

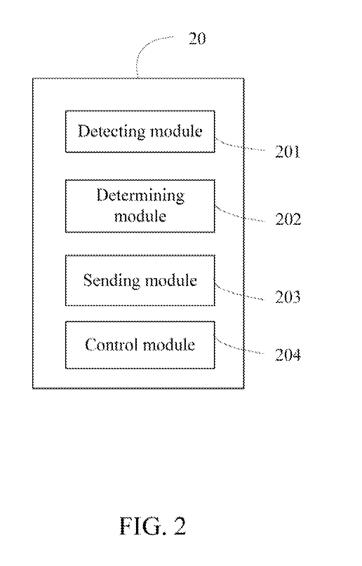

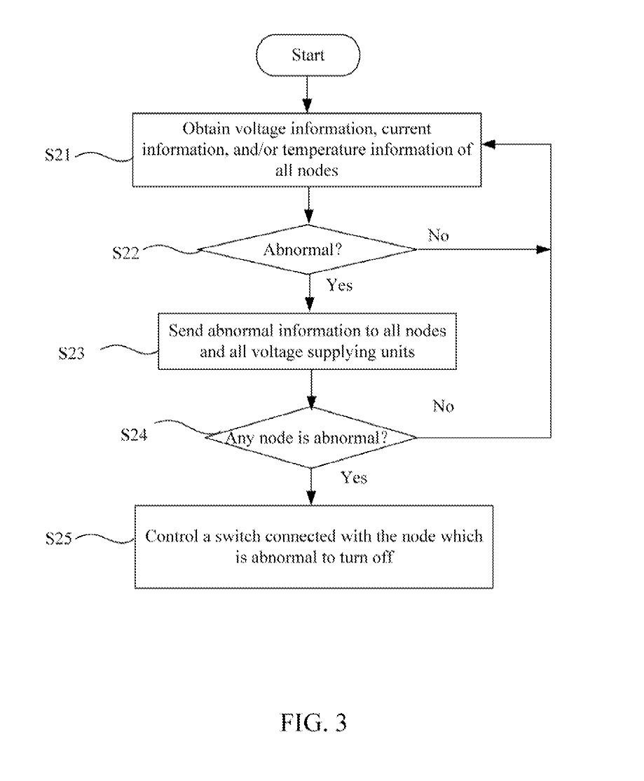

FIG. 2 is a schematic view of a power-off protection system used in the multi-node in FIG. 1. The power-off protection system 20 runs on the voltage dividing board 200. The power-off protection system 20 includes a detecting module 201, a determining module 202, a sending module 203, and a control module 204. Functions of the modules are described with reference to FIG. 3.

FIG. 3 is a flowchart of an embodiment of a power-off protection method for the multi-node system of FIG. 1. The power-off protection method runs on the voltage dividing board 200.

In step S21, the detecting module 201 obtains voltage information, current information, and/or temperature information of all nodes 301, 302, . . . , 30n and of all the power supplying units 101, 102, . . . 10m, periodically.

In step S22, the determining module 202 determines if any of the obtained voltage, current, and temperature information is abnormal. If yes, the procedure goes to step S23. If no, the procedure goes to step S21. The determining module 202 determines whether any obtained voltage, current, and temperature is out of a predetermined range. If any of the obtained voltage, current, and temperature information is out of a predetermined range, such obtained voltage, current and temperature information is regarded as being abnormal.

In step S23, the sending module 203 sends abnormal information to all nodes 301, 302, . . . , 30n and to all power supplying units 101, 102, . . . 10m.

In step S24, the determining module 202 determines if any node 301, 302 , . . . , 30n from the nodes 301, 302, . . . , 30n and the power supplying units 101, 102, . . . 10m is abnormal. If yes, the procedure goes to step S25. If no, the procedure goes to step S21.

In step S25, the control module 204 controls the switch connected with the node that is abnormal to turn off, thereby turning off the power source connected with the node that is abnormal, and preventing any or further damage.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A power-off protection system used in a multi-node system, the multi-node system comprising a plurality of nodes and a plurality of power supplying units, the power-off protection system comprising:
a detecting module obtaining voltage, current, and temperature information of the nodes and the power supplying units in the multi-node system periodically;
a determining module determining if any node from the nodes and any power supplying unit from the power supplying units are abnormal; and
a control module controlling a switch connected with the node that is abnormal to turn off, thereby turning off power source connected with the node that is abnormal.

2. The power-off protection system of claim 1, wherein the determining module further determines if any of the obtained voltage, current, and temperature information is abnormal, and the power-off protection system further comprises a sending module sending abnormal information to all of the nodes when any of the obtained voltage, current, and temperature information is abnormal.

3. The power-off protection system of claim 1, wherein the determining module further determines if any of the obtained voltage, current, and temperature information is abnormal, and the power-off protection system further comprises a sending module, to send abnormal information to all power supplying units when any of the obtained voltage, current, and temperature information is abnormal.

4. The power-off protection system of claim 1, wherein the determining module determines whether any of the obtained voltage, current, and temperature information is out of a predetermined range; if any of the obtained voltage, current, and temperature information is out of a predetermined range, the any of the obtained voltage, current, and temperature information is regarded as being abnormal.

5. The power-off protection system of claim 1, wherein each one of the node is a server.

6. The power-off protection system of claim 1, wherein each one of the node is a mainboard.

7. The power-off protection system of claim 1, wherein the power-off protection system runs on a voltage dividing board which is a programmable chip.

8. A power-off protection method, comprising:
obtaining voltage, current, and temperature information of all nodes and power supplying units in a multi-node system periodically;
determining if any node from the nodes and any power supplying unit of the power supplying units is abnormal; and
controlling a switch connected with the node that is abnormal to turn off, thereby turning off power source connected with the node that is abnormal.

9. The power-off protection method of claim 8, further comprising determining if any of the obtained voltage, current, and temperature information is abnormal, and sending abnormal information to all of the nodes when any of the obtained voltage, current, and temperature information is abnormal.

10. The power-off protection method of claim 8, further comprising determining if any of the obtained voltage, current, and temperature information is abnormal, and sending abnormal information to all of the power supplying units when any of the obtained voltage, current, and temperature information is abnormal.

11. The power-off protection method of claim 8, further comprising determining whether any of the obtained voltage, current, and temperature information is out of a predetermined range; if any of the obtained voltage, current, and temperature information is out of a predetermined range, the any of the obtained voltage, current, and temperature information is regarded as being abnormal.

12. The power-off protection method of claim 8, wherein the power-off protection method is running on a voltage dividing board, the voltage dividing board is a programmable chip.
